(19) United States
(12) Patent Application Publication
(10) Pub. No.: US 2013/0068201 A1
(43) Pub. Date: Mar. 21, 2013

(54) Modular Gear Case for Driving Accessories Associated With an Internal Combustion Engine

(71) Applicant: Glenn D. Miller, Plymouth, MI (US)

(72) Inventor: Glenn D. Miller, Plymouth, MI (US)

(73) Assignee: ECOMOTORS, INC., Allen Park, MI (US)

(21) Appl. No.: 13/607,923

(22) Filed: Sep. 10, 2012

Related U.S. Application Data
(60) Provisional application No. 61/537,418, filed on Sep. 21, 2011.

(51) Int. Cl. F02B 67/04

(52) U.S. Cl. 123/495; 123/198 R; 123/559.1; 123/196 R

(57) ABSTRACT

A modular gear case assembly for an internal combustion engine is disclosed that includes a plate removably coupled to the block of the engine with a through hole in the plate through which an end of the crankshaft of the engine extends. The gear case is coupled to the plate and includes: a central gear that couples with the end of the crankshaft, a first interconnecting gear that meshes with the central gear, a second interconnecting gear that meshes with the central gear, a first side gear that meshes with the first interconnecting gear, a second side gear that meshes with the second interconnecting gear, a housing in which the gears are disposed, and a cover that sealingly couples with the housing.

### CROSS-REFERENCE TO RELATED APPLICATIONS

The present application claims priority benefit from U.S. provisional patent application 61/471,236 filed 4 Apr. 2011.

### FIELD

The present disclosure relates to an internal combustion engine and more particularly to driving accessories associated with the engine.

### BACKGROUND

Internal combustion engines are used to provide power to a vehicle and typically to other devices, such as pumps, generators, and/or compressors. Typically, the engine drives engine accessories and/or vehicle accessories as well via belts, chains, or gears. Front end accessory drive belts or chains are advantageous in that they provide greater flexibility in packaging. However, they are susceptible to breakage, particularly later in their operational life. Truck manufacturers often prefer a more robust solution than a belt or chain driven accessory drive for certain accessories, such as air brake compressors and power steering pumps. It is common to provide a gear case on the front of the engine to drive these accessories. The engine block casting is customized to accommodate such a gear case. This presents no problem for an engine that is designed specifically for a particular application. However, for an engine that is designed for multiple applications, either a conventional belt/chain driven front end accessory drive (FEAD) is tolerated or separate engine block castings are provided for each unique application.

Prior art types of the engine blocks are illustrated by U.S. Pat. Nos. 3,047,085 to Kieffer et al., 6,415,758 to Pierro et al., 7,047,929 to Aketa, et al. The U.S. Pat. No. 6,415,758 to Pierro et al., for example, teaches an engine block having machined front and rear faces, in which each of the front and rear faces is capable of receiving and sealing against a housing enclosing a gear train for coupling the engine crankshaft to a camshaft of the engine. The front face is additionally capable of directly mating with and sealing against an engine front cover and the rear face is additionally capable of directly mating with and sealing against a flywheel housing. The same engine block may be selectively assembled into an engine having a front-mounted or a rear-mounted camshaft gear train.

As the size and shape of the drive train housing will usually differ from the size and shape of the engine front cover, or the flywheel housing, the front and rear faces of an engine block will have machined sealing surfaces and holes for receiving fastening elements that are redundant in any selected camshaft gear train configuration. The gear case taught by the U.S. Pat. No. 6,415,758 to Pierro et al. requires customization of the engine block casting, which presents a problem for an engine that is to be used in a variety of applications.

An opportunity exists for an improved system that both allows for both the ability to accommodate a variety of applications with a geared-drive for at least some of the accessories.

### SUMMARY

An internal combustion engine is disclosed which has an engine block having a crankshaft disposed inside the engine block and rotatable about a central axis and a gear case removably secured to the engine block. The gear case has a central gear coupled to an end of the crankshaft and first and second side gears that rotate in response to rotation of the central gear. A first ancillary device mechanically engages with the first side gear and a second ancillary device mechanically engages with the second side gear. The gear case also has a housing to receive the central gear and the side gears and a cover to enclose the housing. The housing and the cover each have an orifice adapted through which the crankshaft extends. A first interconnecting gear is disposed between and mechanically engages the first side gear with the central gear. A second interconnecting gear is disposed between and mechanically engages the second side gear with the central gear.

The cover and the housing each have at least two blind holes to accommodate: a first shaft extending from a first blind hole in the cover through the first side gear and into a first blind hole in the housing and a second shaft extending from a second blind hole in the cover through the second side gear and into a second blind hole in the housing. The first gear engages with the first shaft such that the first shaft rotates with the first gear and the second gear engages with the second shaft such that the second shaft rotates with the second gear. A third shaft extends from a third blind hole in the cover through the first interconnecting gear and into a third blind hole in the housing and a fourth shaft extends from a fourth blind hole in the cover through the second side gear and into a fourth blind hole in the housing. A plate is coupled between the engine block and the gear box. In some embodiments, an additional plate is coupled to the gear box on a side of the gear box distal from the engine block. The first ancillary device is one of an air brake compressor, a power steering fluid pump, and a fuel pump, an auxiliary oil pump, a scavenge oil pump for a dry sump system, and a supercharger.

A gear case assembly for an internal combustion engine is disclosed which includes: a plate removably coupled to the block of the engine with a through hole in the plate through which an end of the crankshaft of the engine extends and a gear case coupled to the plate. The gear case includes a central gear that couples with the end of the crankshaft via a key or other coupler, a first interconnecting gear that meshes with the central gear, a second interconnecting gear that meshes with the central gear, a first side gear that meshes with the first interconnecting gear, a second side gear that meshes with the second interconnecting gear, a housing in which the gears are disposed, and a cover that sealingly couples with the housing. In one embodiment, either the cover or the housing of the gear box is integrally formed with the plate. In another embodiment, the housing of the gear box is coupled to the plate coupled to the engine block with the assembly further including a plate coupled to the cover of the gear box. Alternatively, the cover of the gear box is coupled to the plate coupled to the engine block and the assembly includes a plate coupled to the housing of the gear box.

A first ancillary is mechanically coupled to the first side gear via a first shaft and a second ancillary is coupled to the second side gear via a shaft. The first ancillary is one of: an air brake compressor, a power steering fluid pump, a fuel pump, an auxiliary oil pump, a scavenge oil pump for a dry sump system, and a supercharger.

The gear case may further include an oil fill orifice defined in an upper surface of the gear case and an oil level orifice a side surface of the gear case.

### BRIEF DESCRIPTION OF THE DRAWINGS

FIG. 1 illustrates an isometric view of an engine system wherein a crankshaft extending from the engine is connected with a plurality of accessories by a single belt;

FIG. 2 illustrates a perspective view of the gear case of the present disclosure;

FIG. 3 illustrates an exploded view of the gear case shown in FIG. 2 also showing a portion of a crankshaft of the engine; and

FIG. 4 illustrates a schematic of an opposed-piston, opposed-cylinder engine having a gear case mounted thereon to drive accessories.

### DETAILED DESCRIPTION

As those of ordinary skill in the art will understand, various features of the embodiments illustrated and described with reference to any one of the Figures may be combined with features illustrated in one or more other Figures to produce alternative embodiments that are not explicitly illustrated or described. The combinations of features illustrated provide representative embodiments for typical applications. However, various combinations and modifications of the features consistent with the teachings of the present disclosure may be desired for particular applications or implementations. Those of ordinary skill in the art may recognize similar applications or implementations whether or not explicitly described or illustrated.

By the way of background, truck manufacturers drive certain accessories, such as, an air brake compressor and a power steering pump, by gears so as to avoid front end accessory drive belt breakage that could cause loss of air brakes and/or power steering. Therefore, it is common to provide a gear case on the front of the engine to drive the aforementioned accessories. The U.S. Pat. No. 6,415,758 to Pierro et al., for example, discloses such gear case rigidly connected to the front of the engine. However, for an engine designed for multiple applications in which some accessories are to be gear driven, a modular gear case approach is desired.

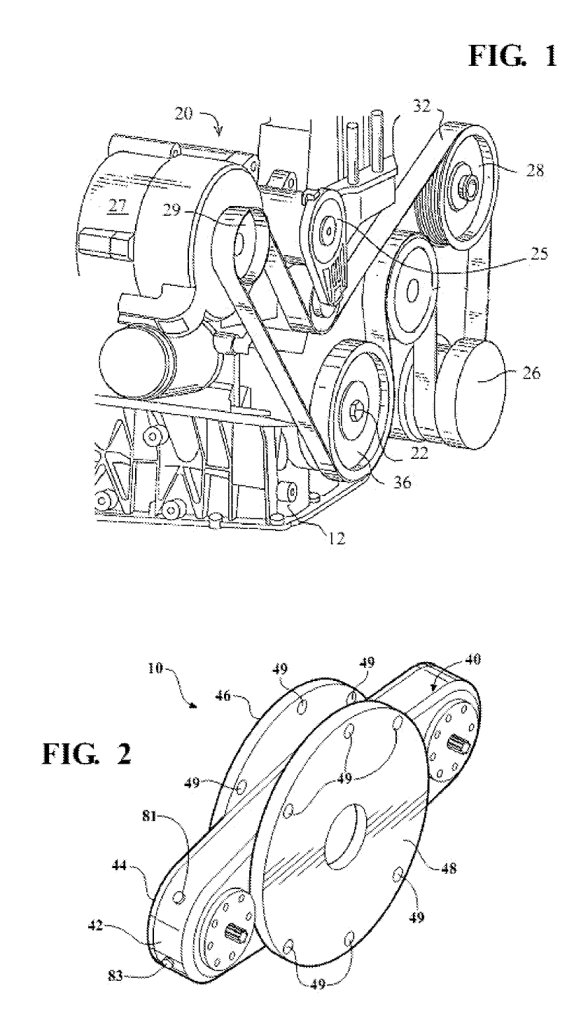

FIG. 1 illustrates an engine system, generally shown at 20, with a crankshaft 22 extending from an engine block 12. Crankshaft 22 is coupled to a pulley 36 to drive via a belt 32 a plurality of pulleys 26 and 28, as examples. Pulleys 26 and 28 are coupled to accessories or ancillary devices, such as a water pump, a power steering pump, an air brake compressor, an alternator, an auxiliary engine oil pump, a supercharger, etc. Many of the accessories are, at best, partially visible in FIG. 1. However, an alternator 27 can be seen in FIG. 1. Belt 32 is typically called a serpentine belt as it takes on a complicated shape to engage multiple pulleys as well as a belt tensioner. Torque from the engine is transmitted through the crankshaft to drive the various ancillary devices that are used in the particular application.

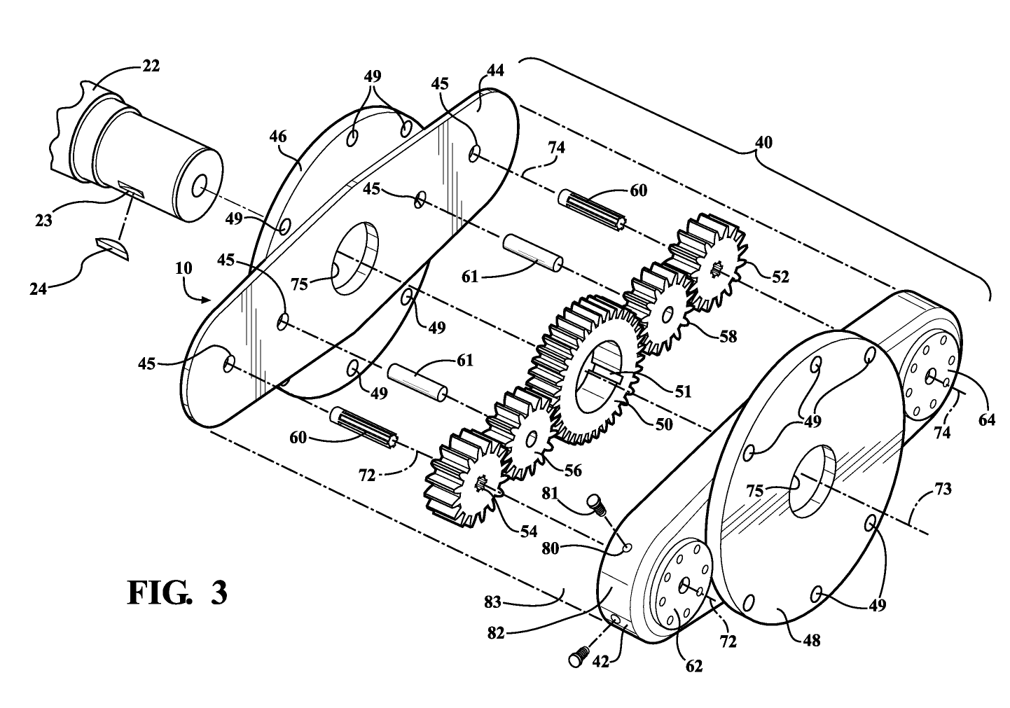

Referring now to FIGS. 2 and 3, a modular gear case 40 is shown in assembled view, FIG. 2, and an exploded view in FIG. 3. Modular gear case 40 has plates 46 and 48 on either side. Orifices 49 to accommodate bolts for mounting to an engine block are shown in FIG. 2. Orifices 49 can be placed in whatever location on plate 46 desired to allow secure mounting on the engine block. In one alternative, modular gear case is coupled to plate 46. In another alternative, plate 46 is formed integrally with cover 44 of gear case 40. Another plate 48 is provided on the front side of gear case 40 so that a conventional chain or belt-driven FEAD may be installed onto plate 48. That is, certain accessories may be gear driven, while other accessories may continue to be belt driven. Although a crankshaft is not shown in FIG. 2, the crankshaft can be extended out of plate 48 and coupled to a pulley to drive one or more belt-driven accessories.

An exploded view of gear set 40 is shown in FIG. 3. A plurality of blind holes 45 are defined in cover 44 to support shafts 60 and 61. Similar blind holes are provided in housing 42 to support shafts 61. Shafts 60 extend through cover 42 to engage with accessories, i.e., extending out of mounting bosses 62 (accessories not shown in FIG. 3). Large through holes 75 are defined in plate 46 (not shown), cover 44, housing 42 (not shown) and plate 48. Through holes 45 are provided to accommodate the end of crankshaft 22 to extend through gear case 40. A keyway 23 is provided on crankshaft 22 with a key 24 inserted in keyway 23. Key 24 engages with a keyway 51 provided on a central gear 50 (FIG. 3). Crankshaft 22 may extend out of plate 48. A pulley (not shown) can be coupled to the end of crankshaft 22 to drive additional accessories via a conventional belt or chain system.

Inside gear case 40 are central gear 50, which rotates with the crankshaft via a key coupling or other alternative coupling system. Central gear 50 meshes with interconnecting gears 56 and 58 that rotate on shafts 61. Shafts 61 may rotate with gears 56 and 58 or alternatively may be stationary with gears 56 and 58 rotating with respect to shafts 61. Side gears 52 and 54 mesh with gears 58 and 56, respectively, with shafts 60 coupling with side gears 52 and 54 so that shafts 60 rotate with gears 52 and 54. In one example, shafts 60 are splined in the region where they couple with side gears 52 and 54, which are complementarily splined. Furthermore, shafts 60 are splined where they couple with accessories (not shown). On the outside of housing 42, a pair of mounting bosses 62 and 64 is provided for mounting accessories. Accessories, such as a power steering pump and an air brake compressor, can be coupled each to one of the mounting bosses. The pump and the compressor each engage with one of shafts 60. When crankshaft 22 rotates, the pump and the compressor are caused to rotate due to the rotation of gears 52, 54, 56 and 58 and shafts 60. Shafts 60 may be splined or have an alternative coupling system. In yet another alternative, a shaft may be provided on the accessory with that shaft coupling with the side gears.

In one alternative, there are no interconnecting gears 56 and 58 and no shafts 61. That is, side gears 52 and 54 mesh directly with central gear 50. It is a cheaper, simpler, and lighter design. However, gears 52 and 54 rotate in the opposite direction from what they would rotate when interconnecting gears 56 and 58 are provided. Furthermore, in some situations, it may be desirable to have mounting bosses 61 and 64 spread farther apart, which the interconnecting gears 56 and 58 allow.

Referring to FIG. 3, an oil fill orifice 80 is provided in housing 42 with a plug 81. Housing 42 is also provided with an oil level orifice 82 with a plug 83. The housing may also have an oil drain orifice with a plug. Such oil drain orifice is not visible in FIG. 3. Gear oil may be provided in gear case 40 to provide lubrication.

Cover 44 mates with housing 42 to hold gear case 40 together. In one embodiment, the two are welded together. Alternatively, a series of bolts and bolt holes are used to couple the two. In such embodiment, a gasket may be employed to aid in holding gear oil inside the housing.

Gear case 40 in FIGS. 2 and 3 accommodates two ancillary devices to be gear driven. However, this is one example. Additional gears may be driven by a pulley (not shown) coupled to crankshaft 22 to drive additional accessories.

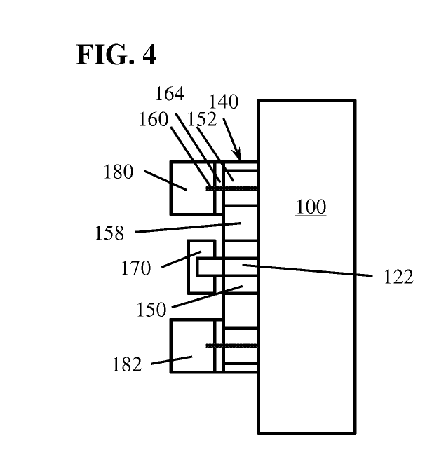

Referring to FIG. 4, an opposed-piston, opposed-cylinder engine 100 having a modular gear case 140 is represented schematically. One example of such an engine is disclosed in U.S. Pat. No. 6,170,443. Engine 100 has a crankshaft 122 that extends through gear case 140. A central gear 150 is coupled to crankshaft 122 in such a manner that the two rotate together. Central gear 150 engages with an interconnecting gear 158, which in turn engages with a side gear 152. Side gear 152 rotates in response to rotation of crankshaft 122. Side gear 152 rotates with shaft 160. Shaft 160 and side gear 152 may be splined, keyed, or coupled in any known manner so that they rotate together. Gear case 140 includes an accessory mounting boss 164, shown in FIG. 4 as extending outwardly from gear case 140, but could alternatively be flush with the surface of gear case 140. Accessory 180 is mounted to accessory mounting boss 164 and driven via shaft 160. Alternatively, accessory 180 could include a shaft that engages with side gear 152.

FIG. 4 shows gear case 140 driving two accessories 180 and 182. Alternatively, gear case 140 could drive more accessories. Selected accessories, e.g., air conditioning compressor, could be driven by a conventional pulley and belt or chain system. To accommodate such accessories for which it is desirable to use the pulley/belt system, a pulley 170 is shown also coupled to crankshaft 122.

While the best mode has been described in detail with respect to particular embodiments, those familiar with the art will recognize various alternative designs and embodiments within the scope of the following claims. While various embodiments may have been described as providing advantages or being preferred over other embodiments with respect to one or more desired characteristics, as one skilled in the art is aware, one or more characteristics may be compromised to achieve desired system attributes, which depend on the specific application and implementation. These attributes include, but are not limited to: cost, strength, durability, life cycle cost, marketability, appearance, packaging, size, serviceability, weight, manufacturability, ease of assembly, etc. The embodiments described herein that are characterized as less desirable than other embodiments or prior art implementations with respect to one or more characteristics are not outside the scope of the disclosure and may be desirable for particular applications.

I claim:

1. An internal combustion engine, comprising:
an engine block having a crankshaft disposed inside the engine block and rotatable about a central axis;
a gear case removably secured to the engine block, the gear case having a central gear coupled to an end of the crankshaft and first and second side gears that rotate in response to rotation of the central gear;
a first ancillary device mechanically engaging with the first side gear; and
a second ancillary device mechanically engaging with the second side gear.

2. The engine of claim 1, wherein the gear case comprises: a housing to receive the central gear and the side gears and a cover to enclose the housing.

3. The engine of claim 2 wherein the housing and the cover each have an orifice through which the crankshaft extends, the engine further comprising:
a first interconnecting gear disposed between and mechanically engaging the first side gear with the central gear; and
a second interconnecting gear disposed between and mechanically engaging the second side gear with the central gear.

4. The engine of claim 2 wherein the cover and the housing each have at least two blind holes, the engine further comprising:
a first shaft extending from a first blind hole in the cover through the first side gear and into a first blind hole in the housing; and
a second shaft extending from a second blind hole in the cover through the second side gear and into a second blind hole in the housing wherein the first gear engages with the first shaft such that the first shaft rotates with the first gear and the second gear engages with the second shaft such that the second shaft rotates with the second gear.

5. The engine of claim 3 wherein the cover and the housing each have four blind holes, the engine further comprising:
a third shaft extending from a third blind hole in the cover through the first interconnecting gear and into a third blind hole in the housing; and
a fourth shaft extending from a fourth blind hole in the cover through the second side gear and into a fourth blind hole in the housing.

6. The engine of claim 1 wherein the gear case comprises a housing and a cover in which the central and side gears are housed, the engine further comprising:
a plate coupled between the engine block and the gear box.

7. The engine of claim 1, further comprising: a plate coupled to the gear box on a side of the gear box distal from the engine block wherein the crankshaft extends through orifices in the gear box and an orifice in the plate with the end of the crankshaft adapted to accept a pulley for driving additional accessories.

8. The engine of claim 1 wherein the first ancillary device is one of an air brake compressor, a power steering fluid pump, and a fuel pump, an auxiliary oil pump, a scavenge oil pump for a dry sump system, and a supercharger.

9. An internal combustion engine having a crankshaft disposed inside the engine, the crankshaft rotatable about a central axis and adapted to transmit engine torque, the engine comprising:
a plate coupled to the engine block;
a gear case removably connected to the engine block, the gear case having: a housing and a cover, a central gear and first and second gears disposed within the housing wherein the central gear is coupled to an end of the crankshaft and first and second gears rotate in response to rotation of the central gear;
a first ancillary device mechanically engaged with the first gear so that the first ancillary device rotates in response to the rotation of the crankshaft; and
a second ancillary device mechanically engaged with the second gear so that the second ancillary device rotates in response to the rotation of the crankshaft.

10. The engine of claim 9, wherein the gear case further includes a first interconnecting gear disposed between the first side gear and the center gear and a second interconnecting gear disposed between the second side gear and the center gear wherein the first interconnecting gear mechanically engages the central gear with the first side gear and the second interconnecting gear mechanically engages the central gear with the second side gear.

11. The engine of claim 9, further comprising:
a first shaft extending between the housing and the cover with the first shaft engaged with the first gear such that the first shaft and the first gear rotate together; and
a second shaft extending between the housing and the cover with the second shaft engaged with the second gear such that the second shaft and the second gear rotate together.

12. The engine of claim 9 wherein the cover is sealingly coupled to the housing; the gear case defines an oil fill hole; and the gear case further includes a plug to seal the oil fill hole.

13. The engine of claim 9 wherein the first ancillary device is a brake air compressor and the second ancillary device is a steering power pump.

14. A gear case assembly for an internal combustion engine, comprising:
a plate removably coupled to the block of the engine with a through hole in the plate through which an end of the crankshaft of the engine extends;
a gear case coupled to the plate, the gear case including:
a central gear that couples with the end of the crankshaft via a key;
a first interconnecting gear that meshes with the central gear;
a second interconnecting gear that meshes with the central gear;
a first side gear that meshes with the first interconnecting gear;
a second side gear that meshes with the second interconnecting gear;
a housing in which the gears are disposed; and
a cover that sealingly couples with the housing.

15. The assembly of claim 14 wherein one of the cover and the housing of the gear box is integrally formed with the plate.

16. The assembly of claim 14 wherein the housing of the gear box is coupled to the plate coupled to the engine block, the assembly further comprising: a plate coupled to the cover of the gear box.

17. The assembly of claim 14 wherein the cover of the gear box is coupled to the plate coupled to the engine block, the assembly further comprising: a plate coupled to the housing of the gear box.

18. The assembly of claim 14 wherein a first ancillary is mechanically coupled to the first side gear via a first shaft and a second ancillary is coupled to the second side gear via a shaft.

19. The assembly of claim 18 wherein the first ancillary is one of: an air brake compressor, a power steering fluid pump, a fuel pump, an auxiliary oil pump, a scavenge oil pump for a dry sump system, and a supercharger.

20. The assembly of claim 14, further comprising:
an oil fill orifice defined in an upper surface of the gear case; and
an oil level orifice defined in a side surface of the gear case.
